(19) United States
(12) Patent Application Publication
(10) Pub. No.: US 2010/0157918 A1
(43) Pub. Date: Jun. 24, 2010

(54) METHOD AND APPARATUS FOR ALLOCATING DEMODULATION REFERENCE SIGNALS

(75) Inventors: Nam Il KIM, Daejeon (KR); Dae Ho KIM, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/552,420

(22) Filed: Sep. 2, 2009

(30) Foreign Application Priority Data
Dec. 22, 2008 (KR) 10-2008-0131749

(51) Int. Cl. H04W 4/00; H04L 27/00

(52) U.S. Cl. 370/329; 375/259

(57) ABSTRACT

Provided are a method and apparatus for allocating DeModulation Reference Signals (DMRSs). The method includes generating DMRSs, and allocating the DMRSs at consecutive subcarrier positions with respect to all the transmit (TX) antennas of each User Equipment (UE) and allocating the DMRSs at different subcarrier positions with respect to each TX antenna of the UE.

### CROSS-REFERENCE TO RELATED APPLICATIONS

This application claims priority under 35 U.S.C. §119 to Korean Patent Application No. 10-2008-0131749, filed on Dec. 22, 2008, in the Korean Intellectual Property Office, the disclosure of which is incorporated herein by reference in its entirety.

### TECHNICAL FIELD

The following disclosure relates to data transmission in a Multiple Input Multiple Output (MIMO) Single-Carrier Frequency Division Multiple Access (SC-FDMA) system, and in particular, to allocation of DeModulation Reference Signals (DMRSs) for DMRS transmission in the uplink transmission of a MIMO SC-FDMA system.

### BACKGROUND

Wireless communication technologies are developing rapidly, and extensive research is being conducted particularly on methods for transmitting a large amount of data at a high rate.

For high-rate data transmission, SC-FDMA has been proposed as a radio access scheme in 3rd Generation Partnership Protocol-Long Term Evolution (3GPP-LTE) uplink transmission.

In the 3GPP LTE, a basic uplink transmission scheme provides orthogonality for transmit (TX) signals between uplink users and it is based on SC-FDMA transmission with a low Peak-to-Average Power Ratio (PAPR). Also, in order to secure a low PAPR, allocation of a frequency band constituting one SC-FDMA symbol uses localized transmission.

FIG. 1 is a diagram illustrating allocation of DMRSs for the uplink of a Single Input system (i.e., a Single Input Single Output system or a Single Input Multiple Output system).

Uplink SC-FDMA traffic data is transmitted over a Physical Uplink Shared CHannel (PUSCH). DMRSs are transmitted using a Frequency Division Multiplexing (FDM) scheme of dividing User Equipments (UEs) in a subcarrier band on a subcarrier group-by-subcarrier group basis and a Code Division Multiplexing (CDM) scheme of allocating the same subcarrier resource in an overlapping manner and dividing UEs by codes.

As illustrated in FIG. 1, in the uplink of a Single Input Single Output system or a Single Input Multiple Output system, DMRSs are divided by FDM between UEs. Herein, the DMRSs of each UE are arranged consecutively in a subcarrier group.

FIG. 2 is a diagram illustrating allocation of DMRSs for the uplink of a MIMO system.

As illustrated in FIG. 2, DMRSs are divided by FDM between UEs and they are divided by CDM between antennas of each UE. The DMRS M-K-I is the 1^{th} DMRS allocated to the K^{th} antenna of the M^{th} UE.

The DMRSs of each antenna in each UE are allocated to the same subcarrier for the same SC-FDMA symbol and are divided by CDM. Therefore, a channel estimation process in a receiver requires an operation of separating DMRSs that are divided and transmitted by CDM.

This operation is performed on the DMRSs of each TX antenna that are received by a receiver. The operation, however, increases the complexity of the channel estimation and causes an error in the channel estimation, thus leading to the performance degradation.

### SUMMARY

In one general aspect of the present invention, a method for allocating DMRSs includes: generating DMRSs; and allocating the DMRSs at consecutive subcarrier positions with respect to all the transmit TX antennas of each UE and allocating the DMRSs at different subcarrier positions with respect to each TX antenna of the UE.

The generating of DMRSs may include cyclically shifting a base sequence as many as the number of subcarriers for each TX antenna.

The DMRSs may be allocated to the respective TX antennas sequentially one by one.

The DMRSs may be allocate to the respective TX antennas one by one in a subcarrier group band where as many DMRSs as the number of the TX antennas of the UE are consecutively allocated.

In another general aspect, an apparatus for allocating DMRSs includes: a multiplexer multiplexing DMRSs by frequency division; and a subcarrier resource mapper allocating the multiplexed DMRSs with respect to TX antennas of each UE, wherein the subcarrier resource mapper allocates the DMRSs at different subcarrier positions with respect to each TX antenna of the UE and allocates the DMRSs at consecutive subcarrier positions with respect to all the TX antennas of the UE.

The DMRSs may be generated by cyclically shifting a base sequence as many as the number of subcarriers for each TX antenna.

The subcarrier resource mapper may allocate the DMRSs to the respective TX antennas one by one in a subcarrier group band where as many DMRSs as the number of the TX antennas of the UE are consecutively allocated.

The subcarrier resource mapper may allocate the DMRSs to the respective TX antennas sequentially one by one.

Other features and aspects will be apparent from the following detailed description, the drawings, and the claims.

### BRIEF DESCRIPTION OF THE DRAWINGS

FIG. 1 is a diagram illustrating allocation of DMRSs for the uplink of a Single Input system.

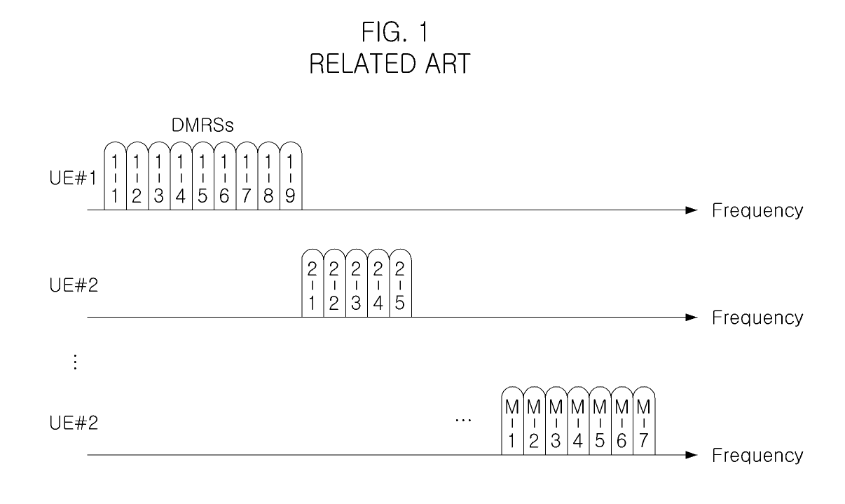

FIG. 2 is a diagram illustrating allocation of DMRSs for the uplink of a MIMO system.

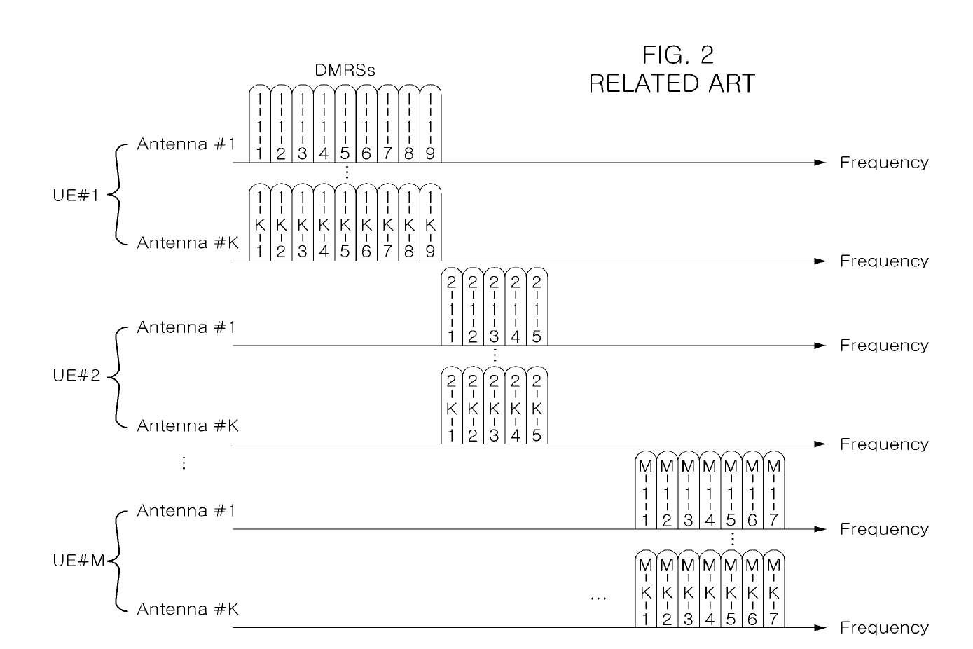

FIG. 3 is a diagram illustrating a TX frame structure of traffic data.

FIG. 4A and FIG. 4B are block diagrams of an uplink MIMO SC-FDMA transmitter unit.

FIG. 5 is a diagram illustrating allocation of DMRSs according to an exemplary embodiment of the present invention.

FIG. 6 is a diagram illustrating allocation of DMRSs according to another exemplary embodiment.

FIG. 7 is a diagram illustrating allocation of DMRSs according to another exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/of systems described herein will be suggested to those of ordinary skill in the art. Also, descriptions of well-known functions and constructions may be omitted for increased clarity and conciseness.

The exemplary embodiments relate to allocation of DMRSs to TX antennas of each UE in order to apply a SC-FDMA system for 3GPP LTE uplink data transmission to a MIMO system.

A 3GPP LTE uplink SC-FDMA system uses an FDM scheme of providing orthogonality by dividing subcarrier allocation bands in a frequency band for allocation of DMRSs between UEs and a CDM scheme of providing orthogonality by dividing codes in the same time/frequency bands.

When such a conventional DMRS allocation method is applied to a MIMO SC-FDMA system, each UE divides DMRSs by CDM between its TX antennas in order to transmit the DMRSs through a plurality of the TX antennas. However, the CDM-based DMRS allocation between the TX antennas of each UE increases the complexity of a channel estimator, which performs channel estimation in a data demodulator of a Base Station (BS) receiver, and also increases a channel estimation error, as described above.

Therefore, the exemplary embodiments provide a method for dividing DMRSs, which are allocated to and transmitted through TX antennas of each UE, by FDM in a system where each UE transmits signals through a plurality of TX antennas by MIMO SC-FDMA.

Herein, DMRSs are divided by FDM between UEs on a subcarrier group basis, and DMRSs are allocated by FDM between TX antennas of each UE.

Hereinafter, the exemplary embodiments will be described in detail with reference to the accompanying drawings.

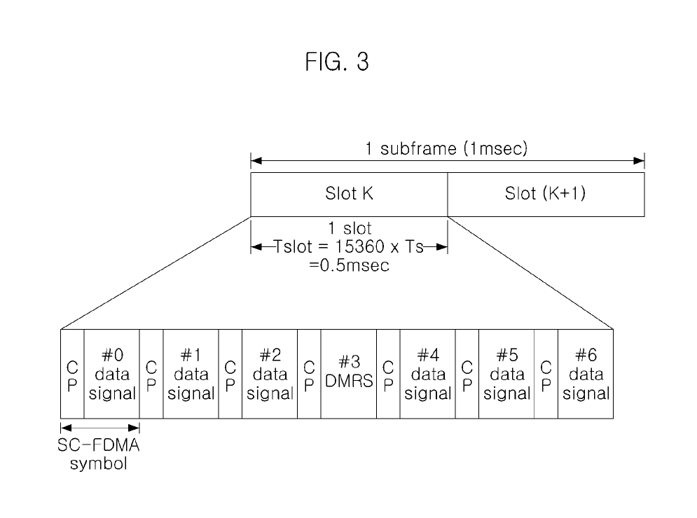

FIG. 3 is a diagram illustrating a TX frame structure of traffic data.

Referring to FIG. 3, a TX frame of SC-FDMA traffic data in the 3GPP LTE is configured to include radio frames, subframes, slots, and SC-FDMA symbols.

Each radio frame has a time length of 10 ms and includes 10 subframes. Thus, as illustrated in FIG. 3, each subframe has a time length of 1 ms and includes 2 slots.

Each slot includes 7 SC-FDMA symbols. Each SC-FDMA symbol has a Cyclic Prefix (CP).

Uplink SC-FDMA traffic data is transmitted over a PUSCH. Herein, the 0^{th}, 1^{st}, 2^{nd}, 4^{th}, 5 and 6^{th} SC-FDMA symbols among a total of 7 SC-FDMA symbols are transmitted by a TX slot. Traffic data is encoded, modulated and transmitted by the 0^{th}, 1^{st}, 2^{nd}, 4^{th}, 5^{th} and 6^{th} SC-FDMA symbols, and a DMRS is transmitted by the 3^{rd} SC-FDMA symbol.

The DMRS is used for channel estimation and Signal-to-Noise Ratio (SNR) estimation in a receiver, and it is used to demodulate/decode the data in a signal transmitted over the PUSCH.

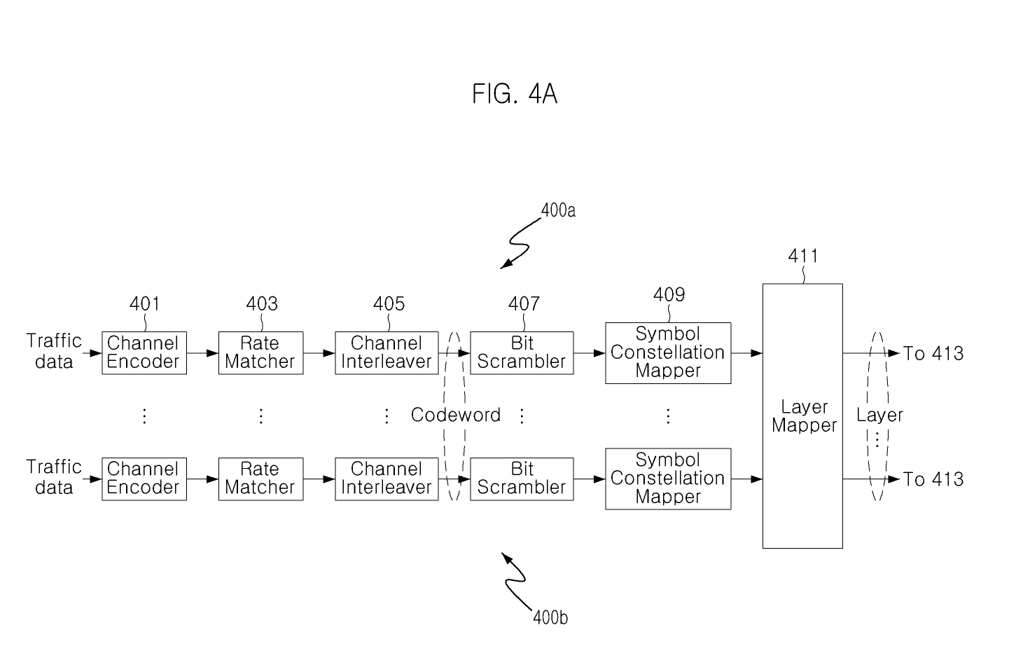

FIG. 4A and FIG. 4B are block diagrams of an uplink MIMO SC-FDMA transmitter unit. Block diagrams depicted herein are not separate embodiments regarding to the uplink MIMO SC-FDMA transmitter unit, but show one embodiment as to the uplink MIMO SC-FDMA transmitter unit. In detail, a few signals transmitted from a layer mapper 411 of FIG. 4A are sent to a layer interleaver 413 of FIG. 4B. Also, the same terms of components are used throughout FIGS. 4A and 4B to designate the same or similar function.

Referring to FIG. 4A and FIG. 4B, traffic data received from an upper layer is processed through a channel encoder 401, a rate matcher 403, a channel interleaver 405, a bit scrambler 407 and a symbol constellation mapper 409. Next, it is processed through a layer mapper 411, a layer interleaver 413 and a precoder 415. Thereafter, the traffic data is processed through a transform precoder 417 according to each antenna path.

Control data is processed through a control data encoder and a modulator of a control data generator 419, and a DMRS is generated by a DMRS generator 421.

The output of the transform precoder 417 for the traffic data according to each antennal path, the output signal of the modulator of the control data generator 419 for the control data, and the DMRS generated by the DMRS generator 421 are selected by a multiplexer (MUX) 423 according to the time and the TX mode. Next, it is allocated by a subcarrier resource mapper 425 to a subcarrier of a frequency band. Then, it is transformed using Inverse Fast Fourier Transform (IFFT) by an IFFT processor 427. Thereafter, a CP is inserted by a CP inserter 429. Then, it is transmitted through each antenna.

Herein, a DMRS r_{u,v}^{(α)}(n) generated by the DMRS generator 421 is generated by a cyclic shift a of a base sequence r̅_{u,v}(n) as Equation (1) below.

r_{u,v}^{(α)}(n)=e^{jon} r̅_{u,v}(n), 0≦n≦M_{sc}^{RS} (1)

Herein, M_{sc}^{RS} is the number of subcarriers for transmission of DMRSs in each SC-FDMA symbol.

Thus, a plurality of DMRS sequences are generated by the cyclic shift a.

The base sequence r̅_{u,v}(n) is determined according to a group number u ∈ {0, 1, . . . , 29} and a base sequence number v in the group.

Herein, if the number of TX subcarriers is equal to or smaller than 60, v=0; and if not, v=0, 1.

The base sequence r̅_{u,v}(n) may be generated by the q^{th} root Zadoff-Chu sequence as Equation (2) below.

r̅_{u,v}(n)=x_{q}(n mod N_{ZC}^{RS}), 0≦n≦M_{sc}^{RS} (2)

Herein, the q^{th} root Zadoff-Chu sequence is expressed as Equation (3) below.

$${x}_{q} ( m ) = {e}^{- j \frac{π qm ( m - 1 )}{N \frac{RS}{ZC}}} , 0 \leq m \leq {N}_{ZC}^{RS} - 1 \qquad ( 3 )$$

Herein, q=└ q̅+½┘+v·(−1)^{└2 q̅┘} and q̅=N_{ZC}^{RS}·(u+1)/31. Also, the length N_{ZC}^{RS} of the Zadoff-Chu sequence is the largest prime number satisfying N_{ZC}^{RS}<M_{sc}^{RS}

Also, the base sequence r̅_{u,v}(n) may be generated as Equation (4) below.

r̅_{u,v}(n)=e^{jφ(n)π/4}, 0≦n≦M_{sc}^{RS}−1 (4)

Herein, M_{sc}^{RS} is the number of subcarriers for transmission of DMRSs in each SC-FDMA symbol, as described above.

### Embodiment 1

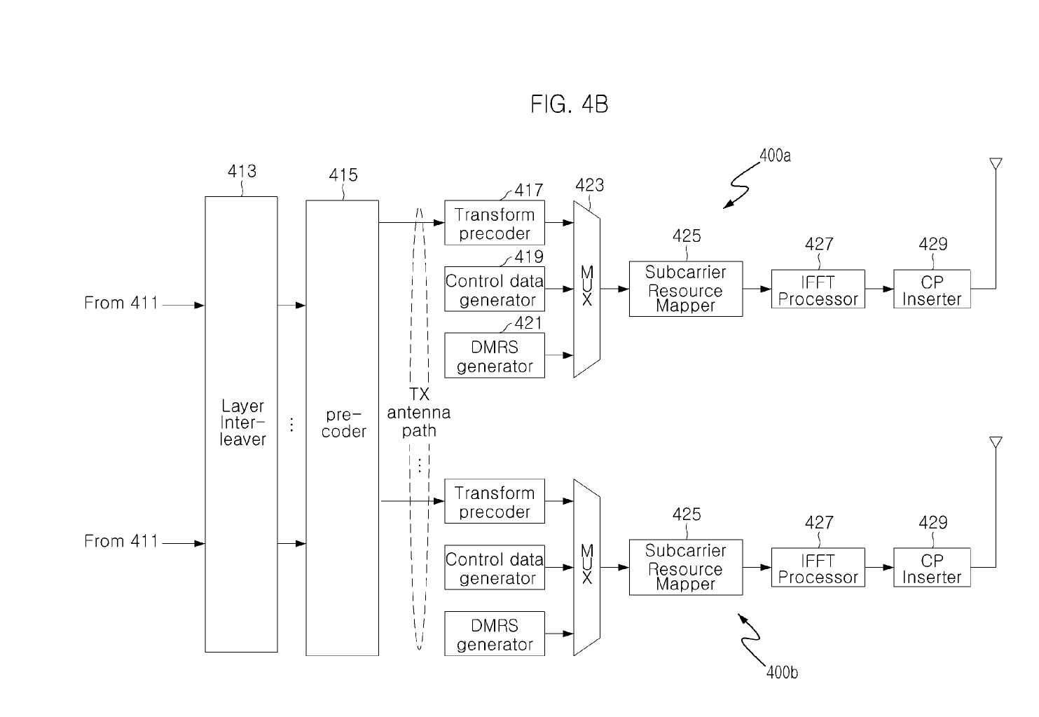

FIG. 5 is a diagram illustrating an exemplary embodiment of the present invention where an UE allocates DMRSs through 2 TX antennas.

Referring to FIG. 5, an UE transmitting signals through 2 TX antennas allocates DMRSs to the TX antennas by alternately allocating the positions of the DMRSs in subcarrier group bands allocated to the TX antennas.

That is, all the DMRSs for the 2 TX antennas are consecutively allocated at the subcarrier positions for the UE, but the DMRSs for each TX antenna are alternately allocated at the subcarrier positions without an overlap therebetween.

A base sequence r̅_{u,v}(n) has orthogonality by using a CAZAC sequence of a cyclic shift type. Thus, a Zadoff-Chu sequence, a kind of CAZAC sequence, may be used as described above.

If the UE uses 2 TX antennas, a DMRS r_{u,v}^{(α)}(n) is generated by a base sequence r̅_{u,v}(n) and a cyclic shift a as Equation (5) below.

r_{u,v}^{(α)}(n)=e^{jon} r̅_{u,v}(n), 0≦n≦M_{sc}^{RS} (5)

Herein, M_{sc}^{RS} is the number of subcarriers for transmission of DMRSs in each SC-FDMA symbol for each TX antenna.

In this embodiment, if the number of subcarriers allocated to each SC-FDMA of the UE is N_{SC},

$${M}_{sc}^{RS} = \frac{{N}_{SC}}{2} ,$$

because each UE has 2 TX antennas

That is, the length M_{sc}^{RS} of a sequence required for each TX antenna is equal to

$$\frac{{N}_{SC}}{2} ,$$

for the number N_{SC} of subcarriers allocated to each SC-FDMA.

Thus, DMRSs allocated to each TX antenna are expressed as Equation (6) below.

$${r}_{2 k + ( {k}_{0} + q ) \% 2}^{q} = \{ \begin{matrix}{r}_{u , v}^{α} ( k ) & k = 0 , 1 , … , {M}_{sc}^{RS} - 1 \\ 0 & otherwise\end{matrix} \qquad ( 6 )$$

Herein, q is a TX antenna number in the UE, k is a subcarrier number for each TX antenna, and k₀ is a position offset of the subcarrier, and (k₀+q)%2 denotes the remainder of the division of (k₀+q) by 2 (i.e., the number of TX antennas), that is, a modulus operation.

### Embodiment 2

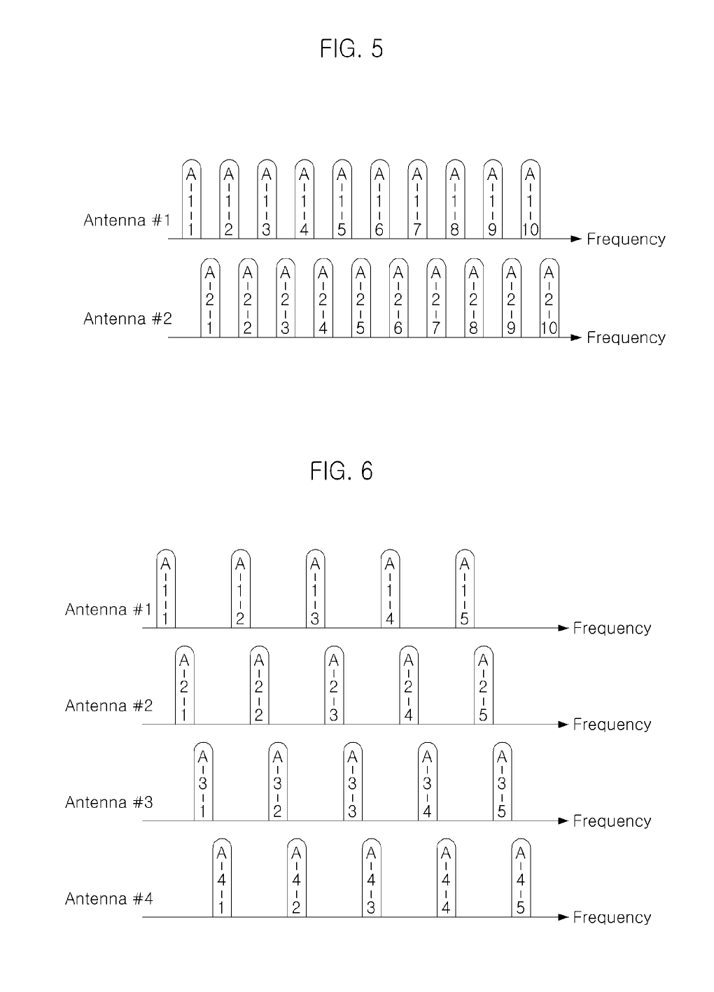

FIG. 6 is a diagram illustrating another exemplary embodiment where each UE allocates DMRSs through 4 TX antennas.

Referring to FIG. 6, an UE transmitting signals through 4 TX antennas allocates DMRSs to the TX antennas by allocating a DMRS to each TX antenna only at one subcarrier position among the 4 consecutive subcarrier positions.

That is, all the DMRSs for the 4 TX antennas are consecutively allocated at the subcarrier positions for the UE, but the DMRSs for each TX antenna are alternately allocated at the subcarrier positions without an overlap therebetween.

As described above, the length M_{sc}^{RS} of a sequence required for each TX antenna is equal to

$$\frac{{N}_{SC}}{4} ,$$

for the number N_{SC} of subcarriers allocated to each SC-FDMA with respect to the 4 TX antennas.

Thus, DMRSs allocated to each TX antenna are expressed as Equation (7) below.

$${r}_{4 k + ( {k}_{0} + q ) \% 4}^{q} = \{ \begin{matrix}{r}_{u , v}^{α} ( k ) & k = 0 , 1 , … , {M}_{sc}^{RS} - 1 \\ 0 & otherwise\end{matrix} \qquad ( 7 )$$

Herein, q is a TX antenna number in the UE, k is a subcarrier number for each TX antenna, and k₀ is a position offset of the subcarrier, and (k₀+q)%4 denotes the remainder of the division of (k₀+q) by 4 (i.e., the number of TX antennas), that is, a modulus operation.

### Embodiment 3

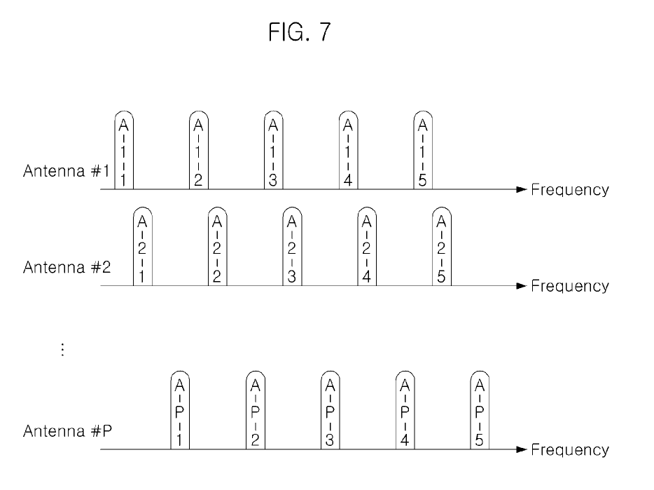

FIG. 7 is a diagram illustrating another exemplary embodiment where each UE allocates DMRSs through P TX antennas.

For the number N_{SC} of subcarriers allocated to each SC-FDMA with respect to the P TX antennas, the length M_{sc}^{RS} of a sequence required for each TX antenna is equal to

$$\frac{{N}_{SC}}{P} .$$

Thus, for each UE transmitting MIMO SC-FDMA through P TX antennas, DMRSs allocated to each TX antenna are expressed as Equation (8) below.

$${r}_{Pk + ( {k}_{0} + q ) \% P}^{q} = \{ \begin{matrix}{r}_{u , v}^{α} ( k ) & k = 0 , 1 , … , {M}_{sc}^{RS} - 1 \\ 0 & otherwise\end{matrix} \qquad ( 8 )$$

Herein, q is a TX antenna number in the UE, k is a subcarrier number for each TX antenna, and k₀ is a position offset of the subcarrier, and (k₀+q)%P denotes the remainder of the division of (k₀+q) by P (i.e., the number of TX antennas), that is, a modulus operation.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for allocating DeModulation Reference Signals (DMRSs), comprising:
generating DMRSs; and
allocating the DMRSs at consecutive subcarrier positions with respect to all transmit (TX) antennas of each User Equipment (UE) and allocating the DMRSs at different subcarrier positions with respect to each TX antenna of the UE.

2. The method of claim 1, wherein the generating of DMRSs comprises cyclically shifting a base sequence as many as the number of subcarriers for each TX antenna.

3. The method of claim 1, wherein the allocating of the DMRSs allocates the DMRSs to the respective TX antennas sequentially one by one.

4. The method of claim 1, wherein the allocating of the DMRSs allocates the DMRSs to the respective TX antennas one by one in a subcarrier group band where as many DMRSs as the number of the TX antennas of the UE are consecutively allocated.

5. An apparatus for allocating DeModulation Reference Signals (DMRSs), comprising:
a multiplexer multiplexing DMRSs by frequency division; and
a subcarrier resource mapper allocating the multiplexed DMRSs with respect to transmit (TX) antennas of each User Equipment (UE),
wherein the subcarrier resource mapper allocates the DMRSs at different subcarrier positions with respect to each TX antenna of the UE and allocates the DMRSs at consecutive subcarrier positions with respect to all the TX antennas of the UE.

6. The apparatus of claim 5, wherein the DMRSs are generated by cyclically shifting a base sequence as many as the number of subcarriers for each TX antenna.

7. The apparatus of claim 5, wherein the subcarrier resource mapper allocates the DMRSs to the respective TX antennas one by one in a subcarrier group band where as many DMRSs as the number of the TX antennas of the UE are consecutively allocated.

8. The apparatus of claim 5, wherein the subcarrier resource mapper allocates the DMRSs to the respective TX antennas sequentially one by one.
